(19) United States
(12) Patent Application Publication
(10) Pub. No.: US 2025/0348826 A1
(43) Pub. Date: Nov. 13, 2025

(54) ADVANCED SYSTEMS AND METHODS FOR DYNAMIC ANALYSIS OF ONLINE MEETINGS METADATA

(71) Applicant: Sunshine in Interaction, Wien (AT)

(72) Inventors: Thomas Spielhofer, Wien (AT); Lorenz Glatz, Wien (AT)

(21) Appl. No.: 19/225,747

(22) Filed: Jun. 2, 2025

Related U.S. Application Data
(63) Continuation-in-part of application No. 19/205,445, filed on May 12, 2025.
(60) Provisional application No. 63/645,293, filed on May 10, 2024.
(60) Provisional application No. 63/654,513, filed on May 31, 2024.
(60) Provisional application No. 63/654,382, filed on May 31, 2024.

(51) Int. Cl. G06Q 10/0639

(52) U.S. Cl. CPC G06Q 10/06393

(57) ABSTRACT

A system for dynamically generating and analyzing metadata for online meetings is provided. The system is programmed to: a) store at least one trained machine learning model trained to analyze metadata of a meeting and to output a probability of success of that meeting; b) retrieve metadata for an ongoing online meeting between a plurality of participants; c) execute the trained machine learning model using the retrieved metadata as input, wherein the trained machine learning model outputs a probability score indicative of the meeting's likely success; and d) generate and display a user interface including the probability score.

### CROSS REFERENCE TO RELATED APPLICATIONS

This application is a continuation in part of U.S. patent application Ser. No. 19/205,445, filed May 12, 2025, which claims priority to U.S. Provisional Patent Application No. 63/645,293, filed May 10, 2024. This application also claims priority to U.S. Provisional Patent Application No. 63/654,513, filed May 31, 2024, and to U.S. Provisional Patent Application No. 63/654,382, filed May 31, 2024, which are hereby incorporated by reference in its entirety.

### BACKGROUND

The field of the invention relates generally to analyzing online meeting metadata for reports and probability of meeting success.

As their quality has improved over time online meetings have become increasingly prevalent in various domains, facilitating communication and collaboration among geographically dispersed participants. At the same time online meetings reduce our ability to experience and participate in non-verbal communication, a key component of any human interaction. Existing methods for analyzing the data generated during these meetings are not yet able to substitute for this deficiency, even more so when it comes to providing insights into group dynamics, group behavior and meeting efficiency.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

In one aspect, a system for dynamically generating and analyzing metadata for online meetings is provided. The system includes a computer device includes at least one processor in communication with at least one memory device. The at least one memory device stores computer-implemented instructions that cause the at least one processor to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyze the diarization information to calculate one or more key performance indicators; and e) generate visualization of the key performance indicators to be displayed to one or more participants in the online meeting. The system may have additional, less, or alternate functionalities, including those discussed elsewhere herein.

In another aspect, a computer device for dynamically generating and analyzing metadata for online meetings is provided. The computer device includes at least one processor in communication with at least one memory device. The at least one memory device stores computer-implemented instructions that cause the at least one processor to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyze the diarization information to calculate one or more key performance indicators; and e) generate visualization of the key performance indicators to be displayed to one or more participants in the online meeting. The computer device may have additional, less, or alternate functionalities, including those discussed elsewhere herein.

In further aspect, a computer-implemented method for dynamically generating and analyzing metadata for online meetings is provided. The method is implemented on a computer device including at least one processor in communication with at least one memory device. The computer-implemented method includes: a) receiving at least one stream of at least one of audio and video of an online meeting, wherein the at least one stream includes one or more participants participating in the online meeting; b) extracting a plurality of metadata from the at least one stream; c) performing diarization on the at least one stream and the plurality of metadata the at least one stream to generate diarization information, wherein the diarization information includes information about participation for the one or more participants in the online meeting; d) analyzing the diarization information to calculate one or more key performance indicators; and e) generating visualization of the key performance indicators to be displayed to one or more participants in the online meeting. The method may have additional, less, or alternate functionalities, including those discussed elsewhere herein.

In one aspect, a system for dynamically generating and analyzing metadata for online meetings is provided. The system includes a computer device comprising at least one processor in communication with at least one memory device. The at least one memory device stores computer-implemented instructions that cause the at least one processor to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyzing the diarization information to calculate one or more key performance indicators; and e) generate visualization of the key performance indicators to be displayed to one or more participants in the online meeting. The system may have additional, less, or alternate functionalities, including those discussed elsewhere herein.

In one further aspect, a system for dynamically generating and analyzing metadata for online meetings is provided. The system includes a computer device includes at least one processor in communication with at least one memory device. The at least one memory device stores computer-implemented instructions that cause the at least one processor to: a) store at least one trained machine learning model trained to analyze metadata of a meeting and to output a probability of success of that meeting; b) retrieve metadata for an ongoing online meeting between a plurality of participants; c) execute the trained machine learning model using the retrieved metadata as input, wherein the trained machine learning model outputs a probability score indicative of the meeting's likely success; and d) generate and display a user interface including the probability score. The system may have additional, less, or alternate functionalities, including those discussed elsewhere herein.

In yet another aspect, a computer device for dynamically generating and analyzing metadata for online meetings is provided. The computer device includes at least one processor in communication with at least one memory device. The at least one memory device stores computer-implemented instructions that cause the at least one processor to: a) store at least one trained machine learning model trained to analyze metadata of a meeting and to output a probability of success of that meeting; b) retrieve metadata for an ongoing online meeting between a plurality of participants; c) execute the trained machine learning model using the retrieved metadata as input, wherein the trained machine learning model outputs a probability score indicative of the meeting's likely success; and d) generate and display a user interface including the probability score. The computer device may have additional, less, or alternate functionalities, including those discussed elsewhere herein.

In yet a further aspect, a computer-implemented method for dynamically generating and analyzing metadata for online meetings is provided. The method is implemented on a computer device including at least one processor in communication with at least one memory device. The computer-implemented method includes: a) storing at least one trained machine learning model trained to analyze metadata of a meeting and to output a probability of success of that meeting; b) retrieving metadata for an ongoing online meeting between a plurality of participants; c) executing the trained machine learning model using the retrieved metadata as input, wherein the trained machine learning model outputs a probability score indicative of the meeting's likely success; and d) generating and displaying a user interface including the probability score. The method may have additional, less, or alternate functionalities, including those discussed elsewhere herein.

In an additional aspect, a system for dynamically generating and analyzing metadata for online meetings is provided. The system includes a computer device includes at least one processor in communication with at least one memory device. The at least one memory device stores computer-implemented instructions that cause the at least one processor to: a) receive at least one stream of at least one of audio and video of an online meeting, wherein the at least one stream includes a plurality of participants participating in the online meeting; b) extract a plurality of metadata from the at least one stream; c) perform diarization on the at least one stream and the plurality of metadata the at least one stream to generate diarization information, wherein the diarization information includes information about participation for the plurality of participants in the online meeting; d) analyze the diarization information to calculate one or more key performance indicators (KPIs); and e) generate a report of the key performance indicators to be displayed to one or more participants in the online meeting. The system may have additional, less, or alternate functionalities, including those discussed elsewhere herein.

In another additional aspect, a computer device for dynamically generating and analyzing metadata for online meetings is provided. The computer device includes at least one processor in communication with at least one memory device. The at least one memory device stores computer-implemented instructions that cause the at least one processor to: a) receive at least one stream of at least one of audio and video of an online meeting, wherein the at least one stream includes a plurality of participants participating in the online meeting; b) extract a plurality of metadata from the at least one stream; c) perform diarization on the at least one stream and the plurality of metadata the at least one stream to generate online meeting information, wherein the diarization information includes information about participation for the plurality of participants in the online meeting; d) analyze the online meeting information to calculate one or more key performance indicators (KPIs); and e) generate a report of the key performance indicators to be displayed to one or more participants in the online meeting. The computer device may have additional, less, or alternate functionalities, including those discussed elsewhere herein.

In further aspect, a computer-implemented method for dynamically generating and analyzing metadata for online meetings is provided. The method is implemented on a computer device including at least one processor in communication with at least one memory device. The computer-implemented method includes: a) receiving at least one stream of at least one of audio and video of an online meeting, wherein the at least one stream includes a plurality of participants participating in the online meeting; b) extracting a plurality of metadata from the at least one stream; c) performing diarization on the at least one stream and the plurality of metadata the at least one stream to generate online meeting information, wherein the online meeting information includes information about participation for the plurality of participants in the online meeting; d) analyzing the online meeting information to calculate one or more key performance indicators (KPIs); and e) generating a report of the key performance indicators to be displayed to one or more participants in the online meeting. The method may have additional, less, or alternate functionalities, including those discussed elsewhere herein.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The Figures described below depict various aspects of the systems and methods disclosed. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals. There are shown in the drawings arrangements presently discussed, it being understood, however, that the present embodiments are not limited to the precise arrangements.

FIG. 1 illustrates a timing diagram for a process for dynamically generating and analyzing metadata for online meetings in real-time, in accordance with at least one embodiment.

FIG. 2 illustrates a timing diagram for a process for dynamically analyzing online meeting metadata within the context of a Microsoft Teams call in real-time, in accordance with at least one embodiment.

FIG. 3A illustrates a flow diagram of a process for diarization in the context of online meeting analysis in real-time, in accordance with at least one embodiment of this disclosure.

FIG. 3B illustrates a graph of diarization as provided by process shown in FIG. 3.

FIG. 4 illustrates the flow of an online meeting being analyzed by the processes shown in FIGS. 1-3A.

FIG. 5 illustrates an example computer system for performing the processes shown in FIGS. 1-3A.

FIG. 6 illustrates an example configuration of a client computer device shown in FIG. 5, in accordance with one embodiment of the present disclosure.

FIG. 7 depicts an example configuration of a server computer device, in accordance with one embodiment of the present disclosure.

FIG. 8 illustrates an example process for analyzing and visualizing speaking patterns and interactions during an online meeting.

FIGS. 9A-9C illustrate example charts that may be used with the process shown in FIG. 8.

FIG. 10 illustrates an example process for analyzing and predicting the success of online meetings.

FIG. 11 shows a flow diagram illustrating the process of receiving an input vector with meeting metadata, continuous prediction of meeting success probability, and the training and testing of the machine learning model.

FIG. 12 illustrate an example timeline for a meeting for use with the process shown in FIG. 10.

FIG. 13 illustrates an example dashboard for use with process shown in FIG. 10.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

The present disclosure introduces a system and method for analyzing online meeting metadata to extract valuable insights regarding group dynamics, group intelligence, meeting effectiveness, productivity, and creativity. The system calculates metrics based on the online meeting metadata metrics. These metrics have been shown to be key meeting success indicators in scientific research in a variety of meeting contexts. By leveraging advanced data processing techniques and machine learning algorithms, the system provides detailed analyses of various aspects of online meetings, including participant speaking patterns, audio characteristics, and group performance metrics. The system thus substitutes the deficiency of online meetings in nonverbal communications with providing context and information by extracting information from the metadata of the meeting that is not available to the participants otherwise.

The system described herein comprises components for capturing, processing, and analyzing meeting metadata, as well as modules for generating reports, visualizations, and recommendations to aid in data interpretation. Key components include, but are not limited to, a Meeting Metadata Capture Module, a Data Processing and Analysis Module, a Reporting and Visualization Module, and a Recommendations Module.

The Meeting Metadata Capture Module is responsible for collecting data generated during online meetings, including participant speaking patterns, audio characteristics (such as volume, pitch, and rate of speaking), and metadata related to participant location and date/time of participation. However, for privacy reasons, the content of the meeting itself is not captured.

The Data Processing and Analysis Module utilizes machine learning algorithms and statistical techniques. The module processes the captured metadata to extract relevant insights regarding participant behavior, group dynamics, group intelligence, meeting effectiveness, productivity, and creativity. The module employs techniques such as diarization to segment the audio data and identify individual speakers. The module also uses other algorithms to analyze speaking patterns and audio characteristics to assess participant engagement and communication effectiveness. The online meeting metadata metrics being calculated have been shown to be key meeting success indicators in scientific research in a variety of meeting contexts.

The Reporting and Visualization Module generates comprehensive reports and visualizations in real time, or after the meeting, summarizing the findings from the data analysis. These reports provide insights into various aspects of the online meetings, including participant speaking time, contribution levels, group intelligence and other meeting related scores. Visualizations such as graphs and charts are used to present the data in an easily interpretable format.

The Recommendations Module uses metadata of the group interaction to make recommendations to the meeting participants or other third-parties to increase the overall success of the meeting based on scientific findings. This can happen in real time during the meeting and/or after the meeting as a summary report.

As used herein, an Online Meeting is considered a synchronous communication between two or more participants via an audio or video conferencing tool.

As used herein, Meeting Metadata is data that describes data resulting from an audio or video meeting, including participant speaking patterns, audio characteristics, participant location, and date/time of participation. However, metadata does not include the content of the meeting itself.

As used herein, Diarization is a dataset of all occurrences at which a participant spoke during an audio meeting, including length (but not audio volume, pitch, and rate of speaking.)

As used herein, Group Intelligence is the performance or productivity of a team according to a test measuring team performance introduced in scientific research.

As used herein, an Audio or Video Provider is a company or service provider offering software platforms or applications enabling audio or video meetings.

As used herein, a Host UI includes user interface software provided by the party hosting the audio or video meetings.

As used herein, a Provider Specific Backend includes Backend infrastructure specific to a particular audio or video provider.

As used herein, a Host General Purpose Backend includes the Meeting host's software independent of service provider specifics.

As used herein, a Host Datastore is one or more databases where all metadata is stored.

As used herein, a processor ML (Machine Learning) is a computer program able to learn from experience with respect to some class of tasks.

In at least one embodiment, the machine learning (ML) systems described herein use the diarization and metadata to predict when certain emotions are going to occur and then provide those predictions to the participants. This information may also be provided with recommendations to either prevent or aid in achieving said emotions. Using self-supervised learning, the system is able to analyze the audio streams to extract meaningful latent features directly from raw waveforms. These features capture subtle variations in pitch, tone, and rhythm, which are key for understanding emotional cues. The ML system learns meaningful representations of audio by transforming raw waveforms into feature-rich embeddings, which can then be used for various downstream tasks, such as speech recognition or emotion detection. The model consists of a feature extractor that maps audio input into a high-dimensional latent feature space. A task-specific fine-tuned head is then utilized to interpret these features for downstream applications, such as emotion classification or transcription, ensuring optimal performance across diverse tasks.

The described system and method offer several advantages over traditional diarization approaches, including: i) improved accuracy in speaker segmentation by dynamically adjusting segments based on speech activity; ii) Real-time analysis capabilities enable timely insights into participant behavior and meeting dynamics; and iii) Enhanced efficiency through automated segmentation of audio data, reducing the need for manual intervention.

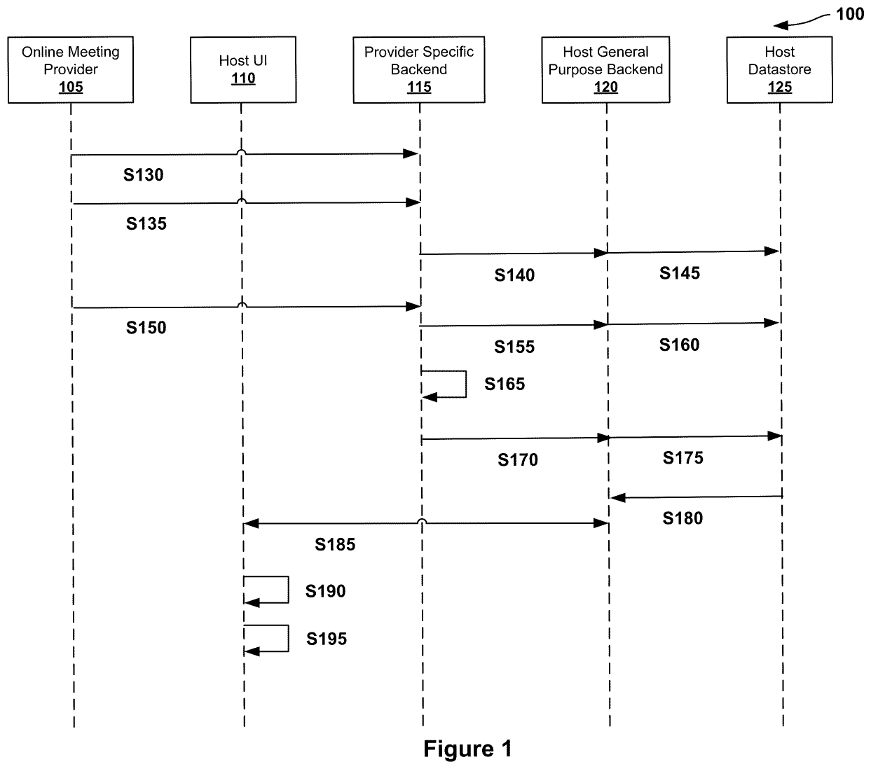

FIG. 1 illustrates a timing diagram for a process 100 for dynamically generating and analyzing metadata for online meetings in real-time, in accordance with at least one embodiment. In the example embodiment, an online meeting provider 105 is in communication with a host system. The host system facilitates the analysis of online meeting metadata by integrating various components to capture, process, and visualize data. The host system may include, but is not limited to, a host UI 110, a provider specific backend 115, a host general purpose backend 120 and at least one host datastore 125. In some embodiments, the host system is associated with one or more of the users attending the online meeting. In other embodiments, the host system is associated with a company or enterprise that is providing the online meeting or has hired the online meeting provider 105.

The online meeting provider 105 is a company or service provider offering software platforms or applications enabling audio and/or video meetings. In many embodiments, the online meeting provider 105 is in communication with a plurality of user device, where the user devices are providing communication with other user devices via the online meeting provider 105. The user devices may include an application that allows them to connect to the online meeting provider 105.

The Host UI 110 includes user interface software provided by the party hosting the audio and/or video meetings. The Provider Specific Backend 115 includes Backend infrastructure specific to a particular audio and/or video provider. The Host General Purpose Backend 120 includes the Meeting host's software independent of service provider specifics. The Host Datastore 125 is one or more databases where all metadata is stored.

In Step S130, the user initiates a call. The process 100 begins when a user initiates S130 an online meeting call through the online meeting provider's platform 105. Upon initiation of the call, the provider-specific backend component 115 extracts S135 the local date and time information of each participant involved in the meeting. In some embodiments, this information is provided by the online meeting provider 105. In Step S135, the Provider-Specific Backend Extracts 115 the Locations of Participants. Simultaneously to step S130, the provider-specific backend 115 extracts S135 the location data of participants, including geographical coordinates or other location identifiers. In Step S140, the Provider-Specific Backend 115 Sends Extracted Metadata to the General Purpose Backend 120. The extracted metadata, including local date and time and participant locations, is sent S140 to the general purpose backend 120 for further processing and then for storage S145 in the datastore 125.

In Step S150, the Online Meeting Provider 105 Continuously Sends Audio Stream data captured during the meeting to the provider specific backend 115 throughout the duration of the meeting. In Step S155, the Provider-Specific Backend 115 Sends Extracted Audio Metadata to the General Purpose Backend 120. The provider-specific backend 115 continuously extracts audio metadata such as pitch, volume, and rate of speaking from the audio stream. This extracted audio metadata is then sent S155 to the general purpose backend 120 for further analysis and to the datastore 125 for storage S160. In Step S165, the Provider-Specific Backend 115 Continuously Calculates Diarization. Diarization is the process of segmenting audio data to identify individual speakers is continuously calculated by the provider-specific backend component 115. In Step S170, the Provider-Specific Backend 115 Sends Calculated Diarization to the General Purpose Backend 120. The calculated diarization information identifies individual speakers and their respective speech segments. In Steps S170 and S175, the calculated diarization is sent to the general purpose backend 120 for subsequent analysis and to the datastore 125 for storage. Steps S150 through S175 continuously repeat as the meeting continues.

In Step S185, the UI 110 Continuously Polls for Diarization from General Purpose Backend 120. The user interface (UI) component 110 continuously polls the general purpose backend 120 to retrieve the latest diarization information stored in the datastore 125. This information may be loaded S180 from the datastore 125 as needed.

In Step S190, the UI 110 Calculates Key Performance Indicators (KPIs) Based on Received Diarization. Upon receiving the diarization data, the UI 110 calculates key performance indicators (KPIs) such as participant speaking time, contribution levels, and other relevant metrics based on the identified speaker segments. Then in Step S195, the UI 110 Visualizes Calculated KPIs and Diarization. The UI component 110 visualizes the calculated KPIs and diarization information in an easily interpretable format, such as graphs, charts, or other visualization tools, providing users with valuable insights into participant behavior and meeting dynamics. The UI component 110 additionally furnishes meeting participants and third-parties with real-time guidance, aiding in enhancing the meeting's success rate.

This detailed description of process 100 illustrates the systematic flow of operations within the system for analyzing online meeting metadata, from data capture and processing to visualization and analysis.

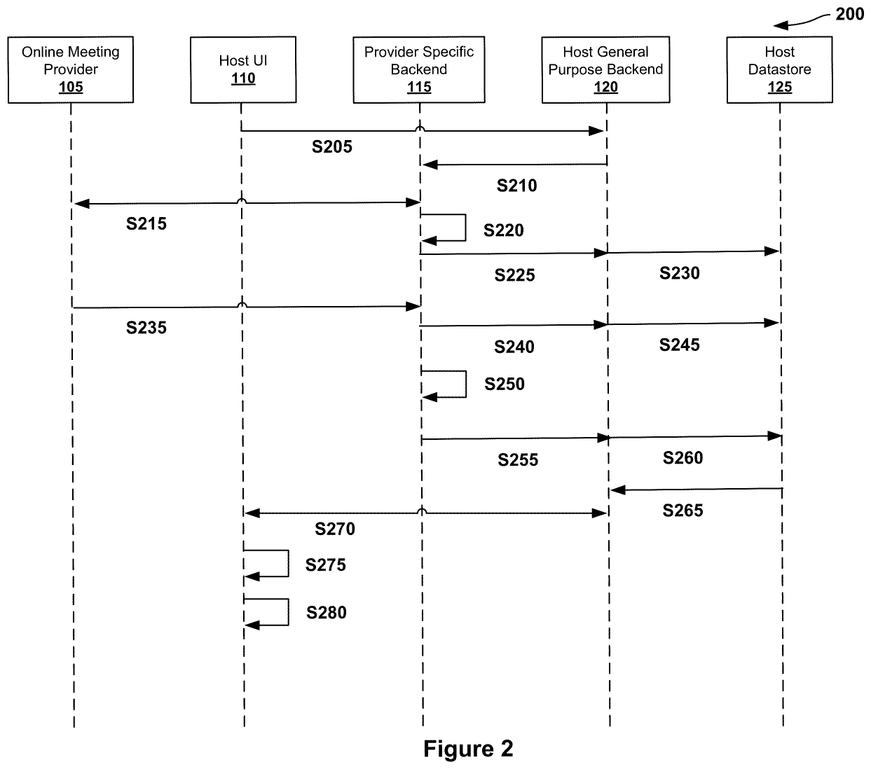

FIG. 2 illustrates a timing diagram for a process 200 for dynamically analyzing online meeting metadata within the context of a Microsoft Teams call in real-time, in accordance with at least one embodiment. One having skill in the art would have understand that process 200 could be used with other online meeting providers 105, such as, but not limited to, Zoom and Google Meetings.

In Step S205, the user requests bot to join the call. The process 200 begins when a user requests a bot to join the online meeting call, specifically within the Microsoft Teams platform. In the example embodiment, the bot is a part of the provider specific backend 115 and the general purpose backend 120. In step S210, the bot joins the call. Upon receiving the user's request, the bot joins the Microsoft Teams call, enabling its integration into the meeting environment. Then the MS Teams Bot Backend 115 extracts S215 local date and time of participants. Upon joining the call, the backend component 115 of the MS Teams bot extracts S220 the local date and time information of each participant involved in the meeting. The MS Teams Bot Backend 115 also extracts S220 location of participants. Simultaneously, the MS Teams bot backend 115 extracts S220 the location data of participants, which may include geographical coordinates or other location identifiers.

In step S225, the MS Teams Bot Backend 115 Sends S225 the extracted metadata to the general purpose backend. The extracted metadata, comprising local date and time and participant locations, is transmitted S225 from the MS Teams bot backend 115 to the general purpose backend 120 for further processing and storage S230 in the datastore 125. The MS Teams 105 Continuously Sends S235 Audio Stream per Participant. Throughout the duration of the meeting, MS Teams 105 continuously streams S235 audio data from each participant participating in the call. The MS Teams Bot Backend 115 sends S240 the extracted audio metadata to the general purpose backend 120. The backend of the MS Teams bot 1215 continuously extracts audio metadata such as pitch, volume, and rate of speaking from the audio streams of each participant. This extracted audio metadata is then transmitted S240 to the general purpose backend 120 for subsequent analysis and to the datastore 125 for storage S245.

The MS Teams Bot Backend 115 continuously calculates S250 diarization. Diarization is the process of segmenting audio data to identify individual speakers is continuously calculated S250 by the backend component of the MS Teams bot 115. The MS Teams Bot Backend 115 sends S255 calculated diarization to the general purpose backend 120. The calculated diarization information, which delineates individual speakers and their respective speech segments, is sent from the MS Teams bot backend 115 to the general purpose backend 120 for further analysis and to the datastore 125 for storage S260.

In Step S270, the UI 110 Continuously Polls for Diarization from General Purpose Backend 120. The user interface (UI) component 110 continuously polls the general purpose backend 120 to retrieve the latest diarization information stored in the datastore 125. This information may be loaded S265 from the datastore 125 as needed.

The UI 110 Calculates S275 Key Performance Indicators (KPIs) based on received diarization. Upon receiving the diarization data, the UI 110 calculates S275 key performance indicators (KPIs) such as participant speaking time, contribution levels, and other relevant metrics based on the identified speaker segments. Then the UI 110 Visualizes S280 calculated KPIs and diarization. Finally, the UI component 110 visualizes S280 the calculated KPIs and diarization information in an easily interpretable format, such as graphs, charts, or other visualization tools, providing users with valuable insights into participant behavior and meeting dynamics. The UI component 110 additionally furnishes meeting participants and third-parties with real-time guidance, aiding in enhancing the meeting's success rate.

This detailed description of process 200 illustrates for analyzing online meeting metadata within the context of a Microsoft Teams call, with potential applicability to other online meeting platforms.

As described herein, the processes 100 and 200 for generating and analyzing metadata for online meetings is performed in real-time as the meeting is occurring to allow for real-time analysis of the meeting. This real-time analysis allows for facilitators to make changes in the meeting as the meeting is occurring to ensure that the participants are all able to participate.

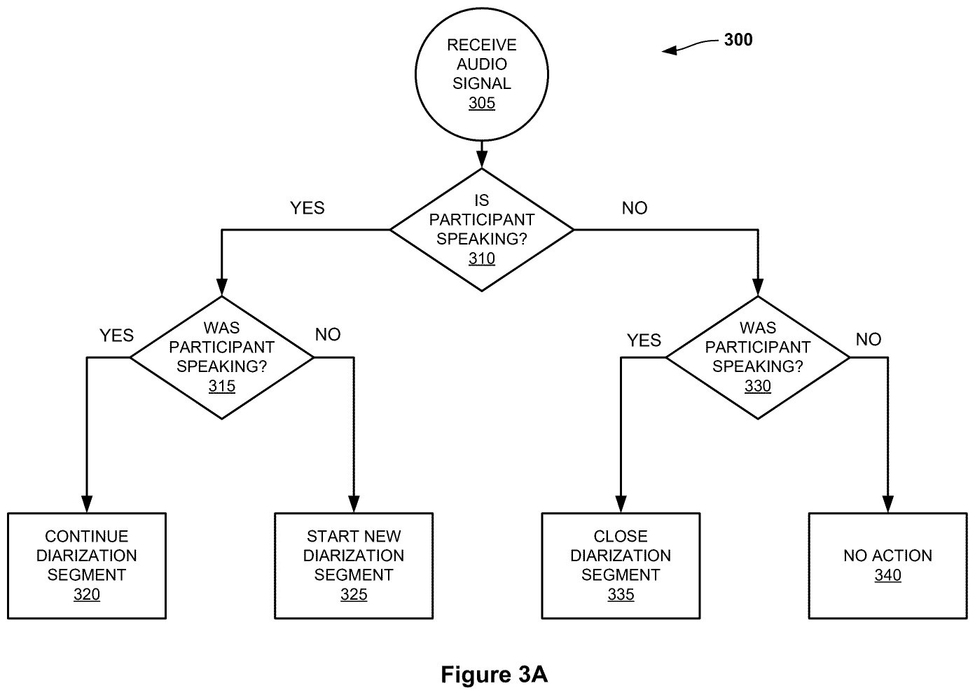

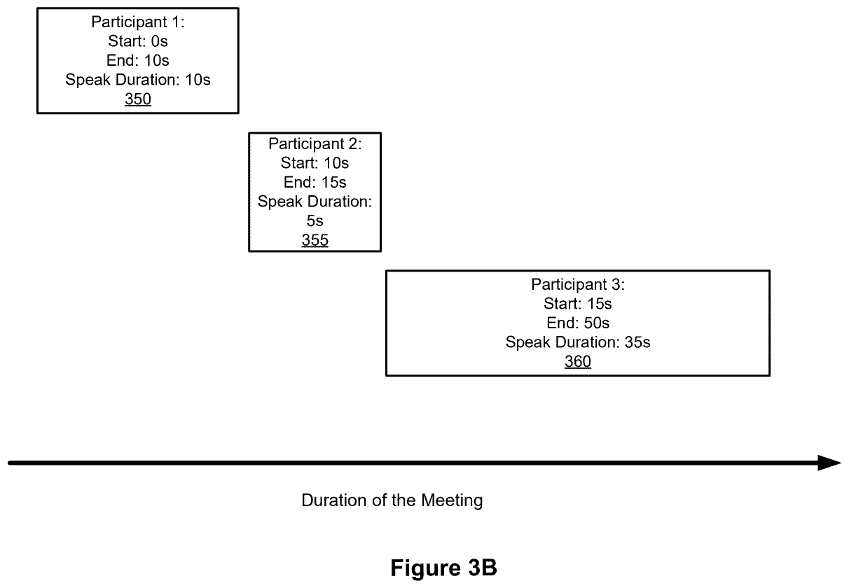

FIG. 3A illustrates a flow diagram of a process 300 for diarization in the context of online meeting analysis in real-time, in accordance with at least one embodiment of this disclosure. For this discussion diarization is the process of segmenting audio data to identify individual speakers and to enable the extraction of valuable insights into participant behavior and meeting dynamics. In the example embodiment, process 300 is performed by the provider specific backend 115 (shown in FIG. 1).

In the example embodiment, the provider specific backend 115 receives 305 the audio signals from online meeting platform 105 (shown in FIG. 1) capturing the speech of participants involved in the meeting. This is similar to step S150 (shown in FIG. 1) and step S235 (shown in FIG. 2). The rest of the steps of process 300 are part of set S165 (shown in FIG. 1) and step S250 (shown in FIG. 2).

The system employs advanced signal processing techniques and machine learning algorithms to determine whether a participant is speaking. This determination is based on factors such as amplitude, frequency, and duration of the audio signal. Upon receiving the audio signal, the provider specific backend 115 employs advanced signal processing techniques and machine learning algorithms to determine 310 whether a participant is speaking. If yes, the provider specific backend 115 checks 315 if participant was speaking before. If yes, the provider specific backend 115 continues 320 the current diarization segment for that participant. If the participant was not speaking, then the provider specific backend 115 starts 325 a new diarization segment for that participant. If the participant is not speaking, the provider specific backend 115 checks 330 if participant was speaking before. If yes, the provider specific backend 115 closes 335 the current diarization segment for that participant. If no one was speaking before, the provider specific backend 115 takes 340 no action.

In the example embodiment, the determination if the Participant is Speaking is done with state of the art “Voice activity detection” mechanisms and programs.

By dynamically adjusting diarization segments based on participant speech activity, the system improves the accuracy and efficiency of online meeting analysis. Additionally, real-time diarization and analysis of meeting metadata enables the system to provide timely insights into participant behavior and meeting dynamics, enhancing the overall effectiveness of the online meeting analysis process.

FIG. 3B illustrates a graph of diarization as provided by process 300 (shown in FIG. 3). The first segment 350 shows that the first participant spoke for 10 seconds. The second segment 355 shows that the second participant spoke for five seconds. And the third segment shows 35 seconds. In some embodiments, there may be blank areas were no participant spoke. In other embodiments, there may be multiple segments for the same participant.

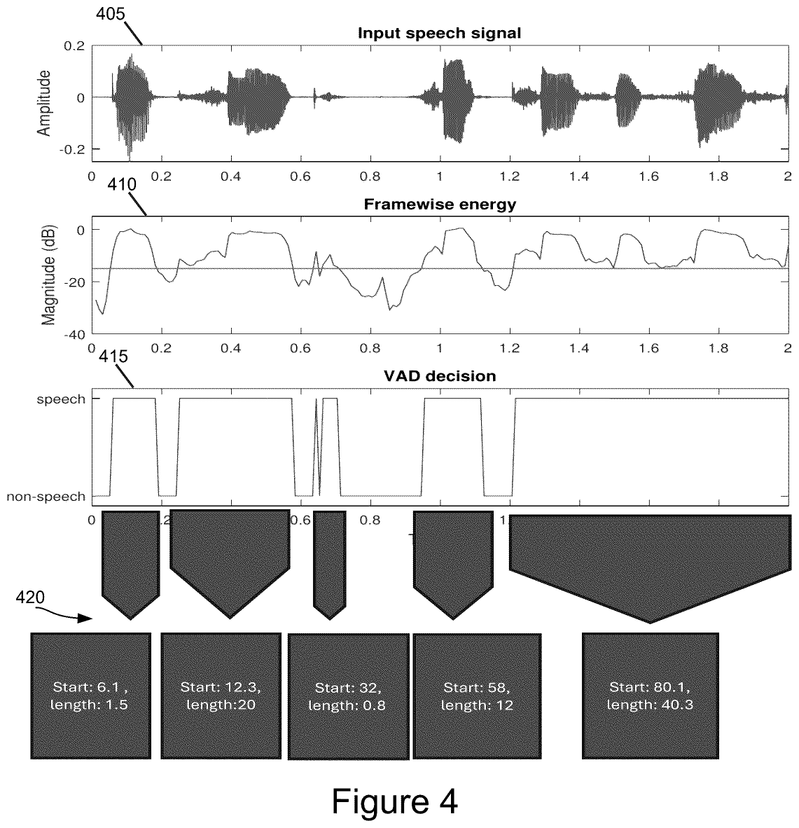

FIG. 4 illustrates the flow of an online meeting being analyzed by the processes 100-300 (shown in FIGS. 1-3A). A first graph 405 illustrates the amplitude of the participant speaking. A second graph 410 illustrates the magnitude of the participant speaking. A third graph 415 illustrates detecting period so speech and no speech. The last section 420 shows the various segments that were determined for diarization.

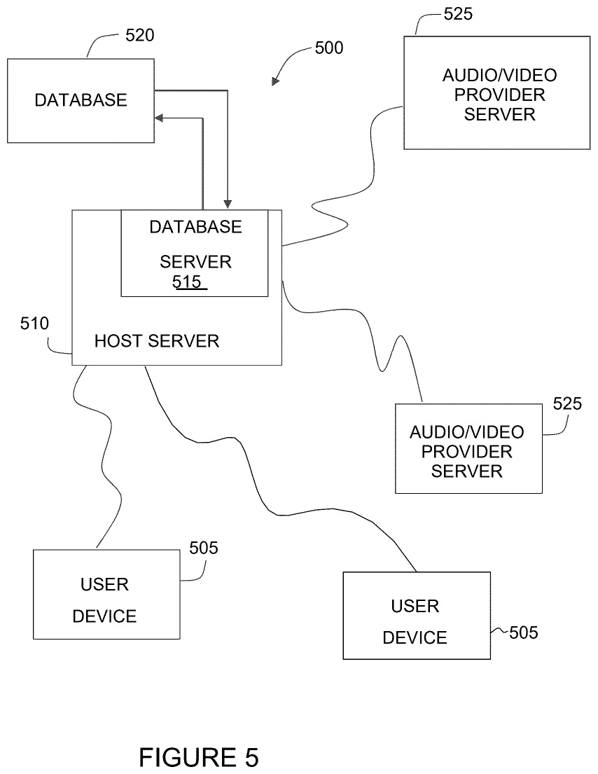

FIG. 5 illustrates an example computer system 500 for performing the processes 100-300 (shown in FIGS. 1-3A). In the example embodiment, the system 500 is used for generating and analyzing metadata for online meetings.

As described below in more detail, the Host server 510 may be programmed for generating and analyzing metadata for online meetings. In some embodiments, the host server 510 may be programmed to: a) receive at least one stream of at least one of audio and video of an online meeting, wherein the at least one stream includes one or more participants participating in the online meeting; b) extract a plurality of metadata from the at least one stream; c) perform diarization on the at least one stream and the plurality of metadata the at least one stream to generate diarization information, wherein the diarization information includes information about participation for the one or more participants in the online meeting; d) analyzing the diarization information to calculate one or more key performance indicators; and e) generate visualization of the key performance indicators to be displayed to one or more participants in the online meeting.

In the example embodiment, user devices 505 are computers that include a web browser or a software application, which enables user devices 505 to communicate with host server 510 using the Internet, a local area network (LAN), or a wide area network (WAN). In some embodiments, the user devices 505 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 505 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the host server 510 is a computer that include a web browser or a software application, which enables host server 510 to communicate with user devices 505 using the Internet, a local area network (LAN), or a wide area network (WAN). Furthermore, the host server 510 may include a host UI 110, a provider specific backend 115, a host general purpose backend 120 and at least one host datastore 125 (all shown in FIG. 1). In some embodiments, the host server 510 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The host server 510 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 515 is communicatively coupled to a database 520 that stores data. In one embodiment, the database 520 is a database that includes diarization data and metadata from online meetings. In some embodiments, the database 520 is stored remotely from the host server 510. In some embodiments, the database 520 is decentralized. In the example embodiment, a person can access the database 520 via the user devices 505 by logging onto host server 510. In some embodiments, the database 520 is similar to, or in communication with, the datastore 125.

Audio/Video provider servers 525 may be any third-party server to provide information that host server 510 is in communication with that provides additional functionality and/or information to host server 510. For example, Audio/Video provider servers 525 may be similar to online meeting providers 105 (shown in FIG. 1). In the example embodiment, Audio/Video provider servers 525 are computers that include a web browser or a software application, which enables Audio/Video provider servers 525 to communicate with the host server 510 using the Internet, a local area network (LAN), or a wide area network (WAN).

In some embodiments, the Audio/Video provider servers 525 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Audio/Video provider servers 525 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

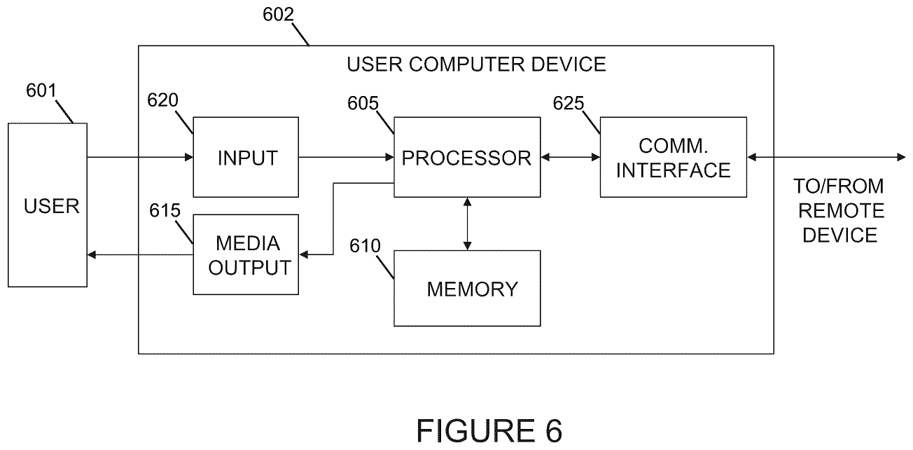

FIG. 6 depicts an example configuration 600 of user computer device 602, in accordance with one embodiment of the present disclosure. In the example embodiment, user computer device 602 may be similar to, or the same as, user device 505 (shown in FIG. 5). User computer device 602 may be operated by a user 601.

User computer device 602 may include a processor 605 for executing instructions. In some embodiments, executable instructions may be stored in a memory area 610. Processor 605 may include one or more processing units (e.g., in a multi-core configuration). Memory area 610 may be any device allowing information such as executable instructions and/or transaction data to be stored and retrieved. Memory area 610 may include one or more computer readable media.

User computer device 602 may also include at least one media output component 615 for presenting information to user 601. Media output component 615 may be any component capable of conveying information to user 601. In some embodiments, media output component 615 may include an output adapter (not shown) such as a video adapter and/or an audio adapter. An output adapter may be operatively coupled to processor 605 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 615 may be configured to present a graphical user interface (e.g., a web browser and/or a client application) to user 601. A graphical user interface may include, for example, an interface for viewing items of information provided by the host server 510 (shown in FIG. 5). In some embodiments, user computer device 602 may include an input device 620 for receiving input from user 601. User 601 may use input device 620 to, without limitation, provide information either through speech or typing.

Input device 620 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 615 and input device 620.

User computer device 602 may also include a communication interface 625, communicatively coupled to a remote device such as host server 510. Communication interface 625 may include, for example, a wired or wireless network adapter and/or a wireless data transceiver for use with a mobile telecommunications network.

Stored in memory area 610 are, for example, computer readable instructions for providing a user interface to user 601 via media output component 615 and, optionally, receiving and processing input from input device 620. A user interface may include, among other possibilities, a web browser and/or a client application. Web browsers enable users, such as user 601, to display and interact with media and other information typically embedded on a web page or a website from Host server 510. A client application may allow user 601 to interact with, for example, Host server 510. For example, instructions may be stored by a cloud service, and the output of the execution of the instructions sent to the media output component 615.

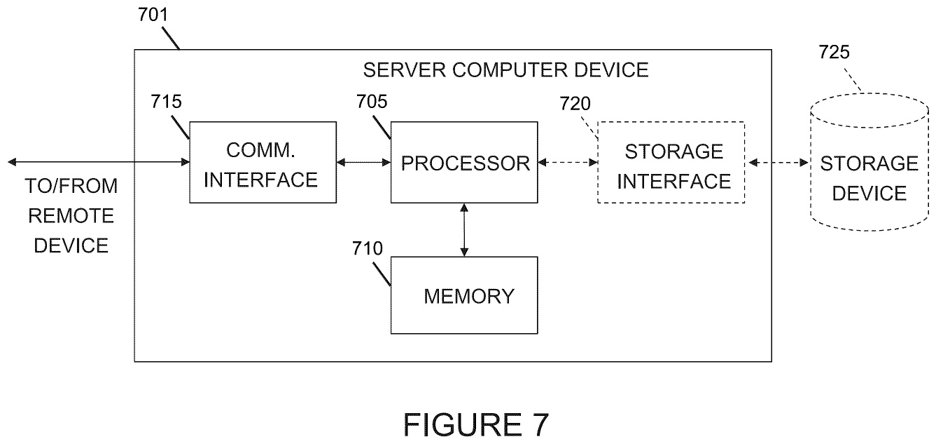

FIG. 7 depicts an example configuration 700 of a server computer device 701, in accordance with one embodiment of the present disclosure. In the example embodiment, server computer device 701 may be similar to, or the same as, online meeting provider 105, host UI 110, a provider specific backend 115, a host general purpose backend 120 (all shown in FIG. 1), host server 510, database server 515, and audio/video provider server 525 (all shown in FIG. 5). Server computer device 701 may also include a processor 705 for executing instructions. Instructions may be stored in a memory area 710. Processor 705 may include one or more processing units (e.g., in a multi-core configuration).

Processor 705 may be operatively coupled to a communication interface 715 such that server computer device 701 is capable of communicating with a remote device such as another server computer device 701, Host server 510, audio/video provider server 525, and user devices 505 (shown in FIG. 5) (for example, using wireless communication or data transmission over one or more radio links or digital communication channels). For example, communication interface 715 may receive input from user devices 505 via the Internet, as illustrated in FIG. 5.

Processor 705 may also be operatively coupled to a storage device 725. Storage device 725 may be any computer-operated hardware suitable for storing and/or retrieving data, such as, but not limited to, data associated with one or more models. In some embodiments, storage device 725 may be integrated in server computer device 701. For example, server computer device 701 may include one or more hard disk drives as storage device 725.

In other embodiments, storage device 725 may be external to server computer device 701 and may be accessed by a plurality of server computer devices 701. For example, storage device 725 may include a storage area network (SAN), a network attached storage (NAS) system, and/or multiple storage units such as hard disks and/or solid-state disks in a redundant array of inexpensive disks (RAID) configuration.

In some embodiments, processor 705 may be operatively coupled to storage device 725 via a storage interface 720. Storage interface 720 may be any component capable of providing processor 705 with access to storage device 725. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 725.

Processor 705 may execute computer-executable instructions for implementing aspects of the disclosure. In some embodiments, the processor 705 may be transformed into a special purpose microprocessor by executing computer-executable instructions or by otherwise being programmed. For example, the processor 705 may be programmed with the instruction such as illustrated in FIGS. 1-3A.

In conclusion, the system and method for dynamic diarization and analysis of meeting metadata in online meeting analysis represent a significant advancement in the field of audio processing and online meeting analytics. The invention has numerous applications across various domains, including remote collaboration, communication analysis, and performance evaluation in virtual environments.

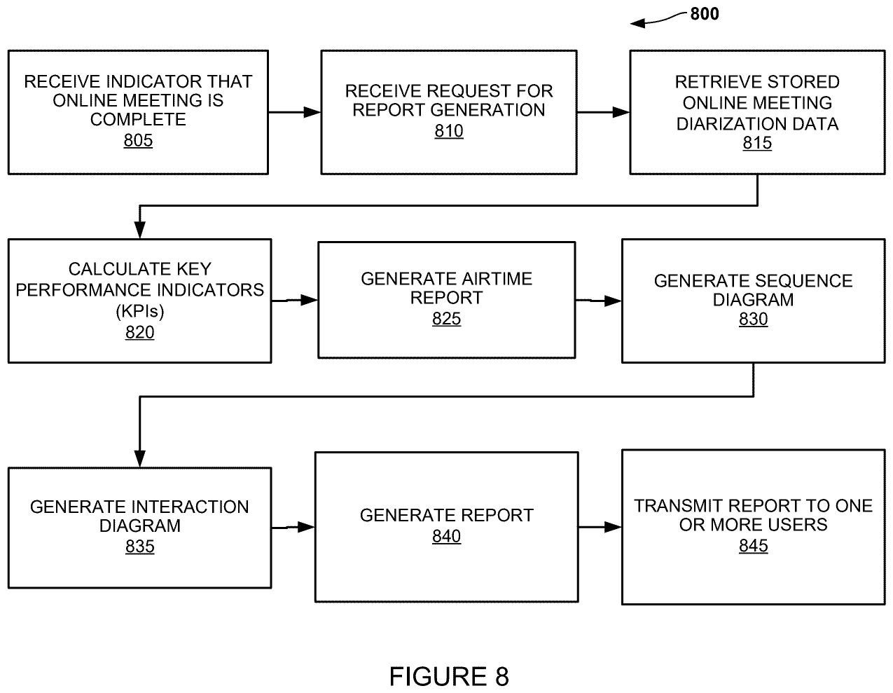

FIG. 8 illustrates an example process 800 for analyzing and visualizing speaking patterns and interactions during an online meeting. The process 800 generates detailed analytics on participant engagement utilizing the diarization data stored in the host datastore 125 (shown in FIG. 1). In the example embodiment, the steps of process 800 are performed by that general purpose backend 120 (shown in FIG. 1).

The steps of process 800 occur after processes 100 and/or 200 have occurred/completed (shown in FIGS. 1 and 2, respectively). In the example embodiment, process 800 occurs after the online meeting has completed. In step S805 the general purpose backend 120 and/or the provider specific backend 115 (shown in FIG. 1) receives an indicator that the online meeting is complete. In some embodiments, the general purpose backend 120 and/or the provider specific backend 115 receives S805 the indicator from the online meeting provider 105 (shown in FIG. 1). In some embodiments, the indicator is forwarded by the provider specific backend 115 to the general purpose backend 120. In step S810, the general purpose backend 120 receive a request for report generation, such as from the general purpose backend 115. In some embodiment, the report request occurs in response to receiving the indicator that the online meeting is complete. In other embodiments, the report requests occurs at a subsequent time, such as at a time when the servers have lower traffic (i.e., 2 AM) or in response to a user request.

In the example embodiment, the general purpose backend 120 retrieves S815 all of the stored online meeting diarization data for the online meeting that the report is being requested for from the host datastore 125. The general purpose backend 120 performs diarization data processing to calculate S820 key performance indicators (KPIs). These KPIs may include metrics such as total speaking time, number of interruptions, participant engagement levels, and more. The general purpose backend 120 traverses the diarization data structure for each participant. This diarization data includes timestamps and identifiers for when each participant spoke during the meeting. For each participant, the algorithm sums up the total time they spoke. This total speaking time is referred to as the “airtime” of the speaker.

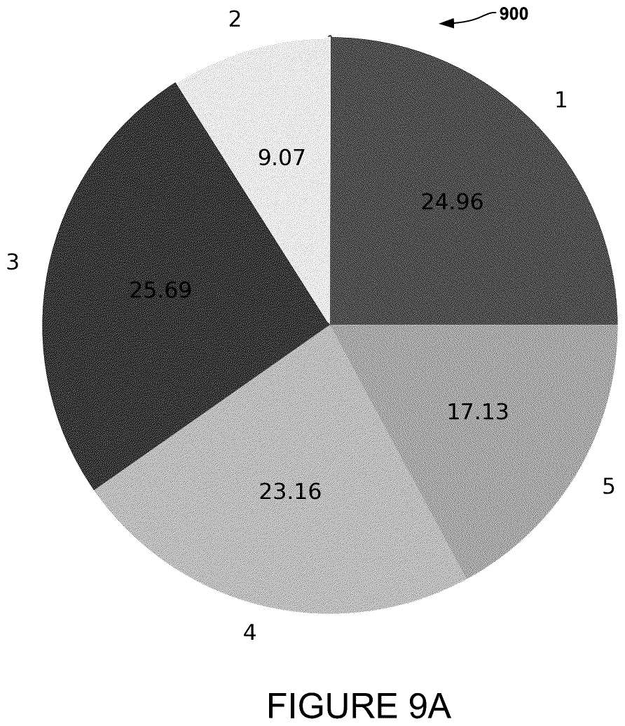

In the example embodiment, the general purpose backend 120 generates S825 an airtime report. Based on the calculated airtime for each participant, the general purpose backend 120 creates a reporting chart, such as, but not limited to, a pie chart 900 (shown in FIG. 9A), or any other type of reporting chart. This pie chart 900, known as the Airtime Report, illustrates the relative speaking times of all participants in percentage terms. The visual representation allows for easy comparison of participant engagement levels.

In the example embodiment, the general purpose backend 120 generates S830 a sequence diagram, such as a bubble chart 905 (shown in FIG. 9B). This chart 905 provides a detailed visualization of when and for how long each participant spoke during the meeting. The x-axis of the Sequence Diagram represents the elapsed meeting time in seconds, while the y-axis features one line per participant. Each bubble on the chart 905 corresponds to an instance of a participant speaking, with the size of the bubble reflecting the duration of the speech segment. This visualization helps in identifying speaking patterns and the dynamics of the conversation flow.

In the example embodiment, the general purpose backend 120 generates S835 an interaction diagram 910. In some embodiments, the general purpose backend 120 calculates centrality and interaction analysis. The general purpose backend 120 calculates the centrality for each participant, which is a measure of their influence and engagement within the meeting. Additionally, the general purpose backend 120 analyzes the relations between all participants to determine interaction patterns and the overall structure of the conversation. The interaction diagram 910 illustrates the interactions between participants. This diagram 910 can show who spoke to whom and the frequency and duration of these interactions, helping to understand the dynamics of the conversation. An example of the interaction diagram 910 is shown in FIG. 9C. The combination of these visualizations and analytics provides a comprehensive overview of the meeting dynamics, facilitating insights into participant engagement, speaking patterns, and the flow of the conversation.

In step S835 centrality S is calculated for all participants. A relation differs from a tie as it reflects a social aspect between two actors that is relevant to the entire network. It is “the measurement of different ties in an overall network.” Relations in these meetings reflect the interaction between two actors over the course of the meetings. This relationship is categorized by when one participant spoke after another participant. They are weighted as follows: the higher the number of interactions, the higher the weight of the relation. Accordingly, the relation between P₁ and P₂ is defined as:

$${R}_{12} = \frac{{\sum }_{t = 1}^{n} {t}_{n} + {t}_{12}}{n} \qquad EQ . 1$$

where n is the number of interactions where P1 spoke after P2.

Based on this, the degree centrality of each team member can be calculated. As the network is constructed using a graph with weighted nodes (with the relation R as described above), the information of the weights can be taken into account when calculating the centrality measure. In one embodiment, a suitable way to compute degree centrality for social networks with weighted nodes is as follows:

$${S}_{t} = {\sum }_{j = 0}^{3} {w}_{i j} \qquad EQ . 2$$

where m is the total number of nodes, w is the weighted adjacency matrix, in which wᵢⱼ is greater than 0 if node i is connected to node j, and the value represents the weight of the tie.

In other embodiments, one having skill in the art that alternate definitions for centrality in social networks with weighted nodes may be used. For example, the centrality definition of “the number of nodes that a focal node is connected to, and the average weight to these nodes adjusted by the tuning parameter, for instance, takes both the weight of the nodes as well as the number of relations an actor has into account. This can be advantageous when we have a network with a very uneven number of relations between its actors. However, this comes at a price: this metric requires a parameter alpha to balance the relevance of node weight and the number of relations. This increases the complexity of the metric and requires empirical work to justify which value to use for alpha in what context. Another approach is to view role positions based on the number of incoming ties, seeing a prestigious actor as one to whom many ties are directed. This forms a concept that has been carried on, for instance, to define centrality in asymmetric networks. Other centrality measures cater to complex networks with subgroups.

In the example embodiment, the general purpose backend 120 generates S840 the report by compiling the previously generated diagrams (Airtime Report, Sequence Diagram, and Interaction Diagram) into a comprehensive report. This report can be formatted as a PDF or other suitable formats. In the example embodiment, the general purpose backend 120 generates S845 transmits the report to one or more users, such as report via email or another communication method specified by the user. This process 800 provides a streamlined and automated way to analyze and visualize the dynamics of online meetings, offering valuable insights into participant engagement and interaction patterns.

In some further embodiments, the provider specific backend 115 and/or the general purpose backend 120 generate recommendations to one or more participants in the meeting of ways to improve the meeting in all dimensions. These include, but are not limited to, productivity, creativity, social cohesion, time management, and meeting success. In some embodiments, the recommendations are based on how previous meetings compared to this one.

FIGS. 9A-9C illustrate example charts that may be used with the process 800 (shown in FIG. 8).

FIG. 9A illustrates a reporting chart 900, which is a pie chart 900. This pie chart 900, known as the Airtime Report, illustrates the relative speaking times of all participants in percentage terms. The visual representation allows for easy comparison of participant engagement levels. While FIG. 9A illustrates a pie chart, one having skill in the art would understand that other types of charts and/or visualizers may be used.

FIG. 9B illustrates a sequence diagram 905, which is a bubble chart. This diagram 905 provides a detailed visualization of when and for how long each participant spoke during the meeting. The x-axis of the Sequence Diagram 905 represents the elapsed meeting time in seconds, while the y-axis features one line per participant. Each bubble on the diagram 905 corresponds to an instance of a participant speaking, with the size of the bubble reflecting the duration of the speech segment. This visualization helps in identifying speaking patterns and the dynamics of the conversation flow.

FIG. 9C illustrates an interaction diagram 910. The general purpose backend 120 calculates centrality and interaction analysis. The general purpose backend 120 calculates the centrality for each participant, which is a measure of their influence and engagement within the meeting. The general purpose backend 120 analyzes the relations between all participants to determine interaction patterns and the overall structure of the conversation. The interaction diagram 910 illustrates the interactions between participants. This diagram 910 can show who spoke to whom and the frequency and duration of these interactions, helping to understand the dynamics of the conversation. The combination of these visualizations and analytics provides a comprehensive overview of the meeting dynamics, facilitating insights into participant engagement, speaking patterns, and the flow of the conversation.

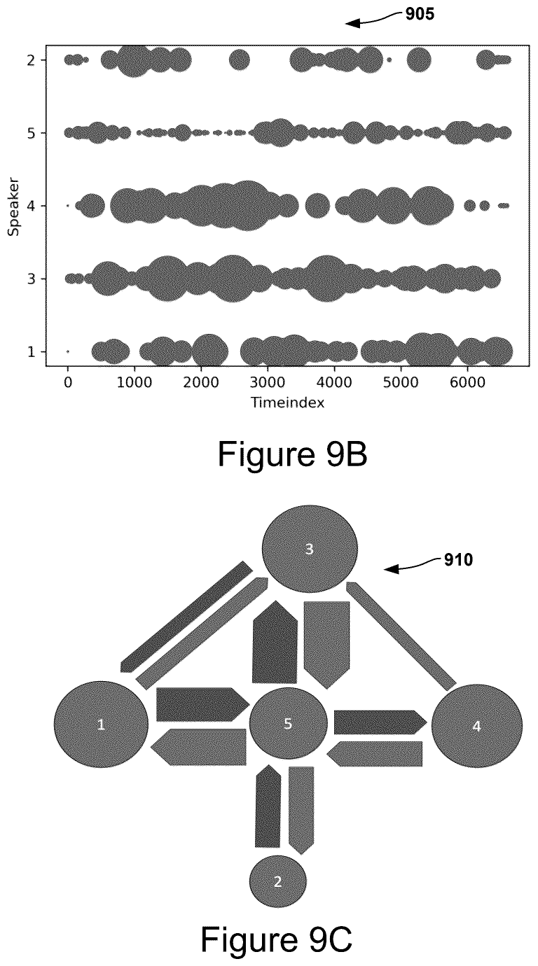

FIG. 10 illustrates an example process 1000 for analyzing and predicting the success of online meetings. The process 1000 generates detailed analytics on participant engagement utilizing the diarization data to predict success of online meeting stored in the host datastore 125 (shown in FIG. 1). In the example embodiment, the steps of process 1000 are performed by that general purpose backend 120 (shown in FIG. 1). For the purposes of this discussion, an online meeting is successful when the meeting meets a predefined success condition. Examples of success conditions include, but are not limited to, a decision being made, a successful pitch, a document being signed, and more specifically a contract being signed in a sales meeting. One having skill in the art would understand that other success conditions may be trained for and predicted.

More particularly, process 1000 relates to using machine learning-based to use historical meeting metadata to provide a probability score indicative of the likely success of a forthcoming meeting or ongoing meeting. The process 1000 provides for predicting the success of meetings using machine learning algorithms. The process 1000 includes periodically collecting metadata from previous meetings and feeding this data into a machine learning model to compute a success probability score for the upcoming or ongoing meetings. More specifically, process 1000 illustrates fetching metadata, processing it through a machine learning model, and displaying the success probability.

In the example embodiment, the general purpose backend 120 retrieves S1005 stored online meeting metadata for the currently occurring online meeting and/or metadata for the last N seconds in the currently occurring online meeting from the host datastore 125. In some embodiments, the general purpose backend 120 is a server. In other embodiments, the general purpose backend 120 is a cloud-based system. The general purpose backend 120 periodically fetches metadata from previous meetings. Metadata includes, but is not limited to, meeting time, participants, agenda, duration, and outcomes.

The general purpose backend 120 includes a machine learning backend (ML Backend). The ML backend receives the fetched metadata and uses it as an input vector for a pre-trained machine learning model. The machine learning model is trained on historical meeting data to predict the success probability of future or subsequent meetings. The machine learning model has been trained using a dataset comprising historical meeting records.

The model is trained to calculate S1010 a meeting success prediction with meeting metadata, such as that from the previous N seconds. In other embodiments, the meeting success prediction is based on the entire online meeting up to that point. In some embodiments, the model computes and outputs S1015 a probability score (PP) ranging from 0 to 1, indicating the likelihood of a meeting's success. In other embodiments, the model outputs prediction information, and the general purpose backend 120 computes S1015 the probability of meeting success (PP). In the example embodiment, the general purpose backend 120 continuously poll S1020 for the current PP and has the ML model update the PP on a periodic basis. In some embodiments, the general purpose backend 120 analyzes the metadata of a meeting (such as the pitch and volume) and to outputs a probability of success of that meeting. In this case not just the diarization of the audiostream is used, but also the changes in pitch and volume are used.

In the example embodiment, the training and test datasets used for this purpose contain the meeting metadata of online video calls plus markers where the success event occurred (in case it occurred at all). The meeting success event depends on the meeting type, e.g., the signing of a contract in a sales meeting. That way, all events that are predictable through patterns in the meeting metadata, such as changes of interaction and/or change of volume, pitch, etc., can be forecasted. For each kind of event, there is a different pretrained machine learning model, which can be further trained with specific meeting data of the organization to adjust to its specific communication culture increasing the accuracy of the prediction.

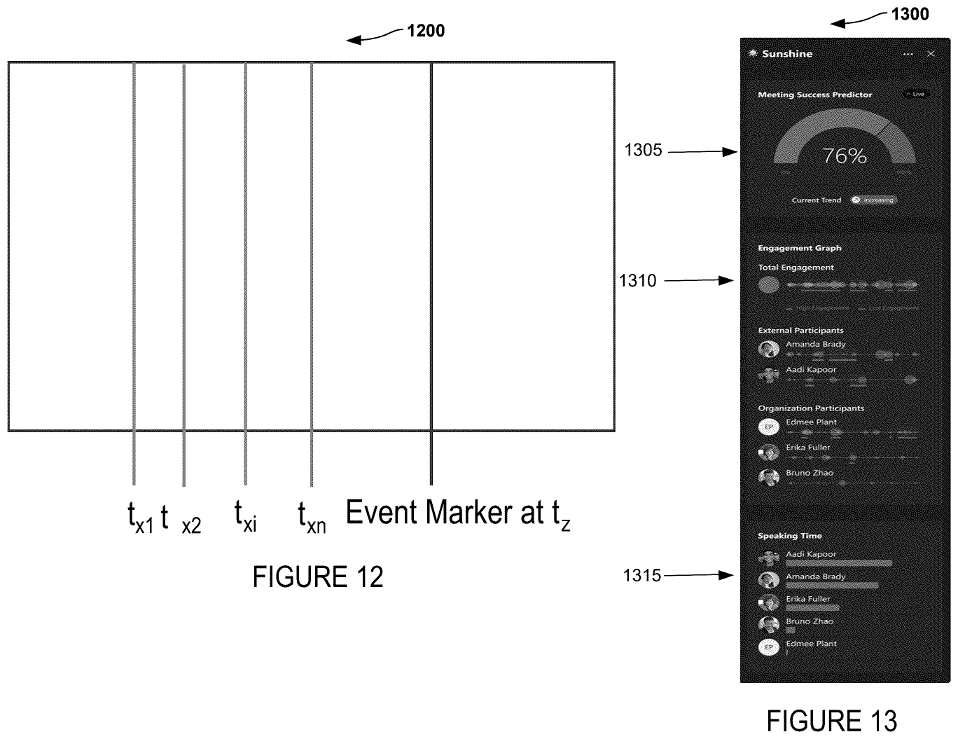

In some embodiments, the provider specific backend 115 and/or the host UI 110 generate S1025 a probability meter diagram based on the PP. An example probability meter diagram 1305 is shown in FIG. 13. The UI 110 is a graphical interface that displays the predicted success probability to the users. The interface can visualize the probability score in various forms, such as graphs or diagrams. The provider specific backend 115 and the UI 110 update S1030 the probability meter diagram 1305 based on the current PP.

In some further embodiments, the provider specific backend 115 and/or the general purpose backend 120 generate recommendations to one or more participants in the meeting of ways to improve the probability of the meeting being successful. In some embodiments, the recommendations are based on how previous meetings compared to this one. In some embodiments, the recommendations are provided during the meeting. In other embodiments, the recommendations are provided prior to the meeting.

In some further embodiments, process 1000 is described as follows. The general purpose backend 120 fetches S1005 metadata of n different moments prior to the current meeting time. The metadata includes relevant information that could impact the meeting's outcome. In these embodiments, the general purpose backend fetches the metadata at periodic intervals. The fetched metadata set is sent to the User ML Backend. The ML backend processes this metadata and prepares it as an input vector for the machine learning model. The machine learning model, based on its training with historical meeting data, calculates the probability S1015 of the forthcoming meeting being successful. The success probability score (PP) ranges between 0 (least likely to be successful) and 1 (most likely to be successful). The calculated probability (PP) is used by the User UI to create S1025 a visual representation 1305, such as a diagram or graph, indicating the predicted meeting success. Users can view this diagram 1305 to assess the likelihood of their meeting's success and make necessary adjustments if needed.

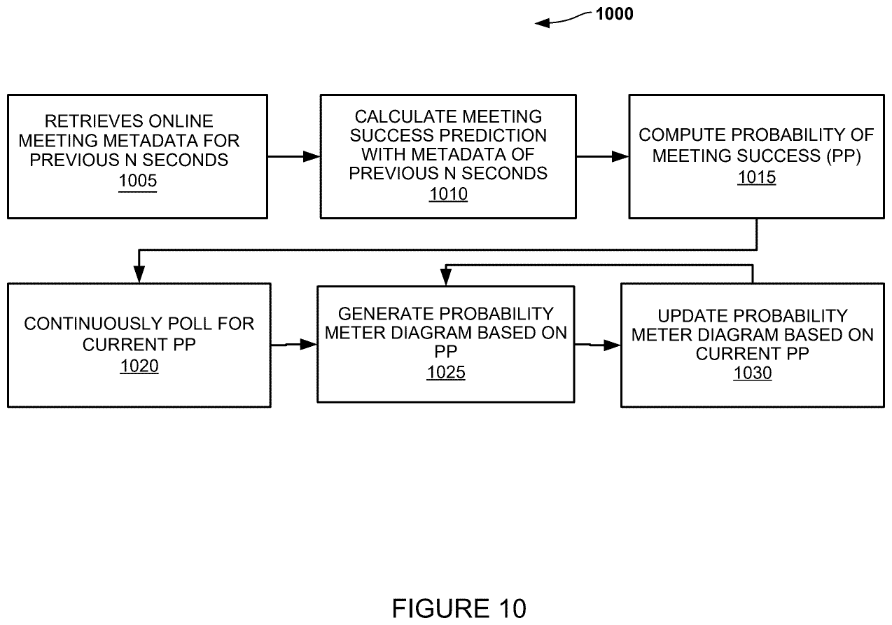

FIG. 11 shows a flow diagram illustrating the process 1100 of receiving an input vector with meeting metadata, continuous prediction of meeting success probability, and the training and testing of the machine learning model. FIG. 11 illustrates several system components. An Input Vector 1105 contains meeting metadata from the past N seconds and meeting context, such as participant time zones. Metadata includes dynamic data like changes in interaction, volume, pitch, etc. A Machine Learning Model 1110 receives the input vector at regular intervals, by default every 1 second. The ML Model 1110 predicts the probability of meeting success 1115, outputting this as a percentage (PP). The training and testing datasets comprise historical meeting data, including metadata from online video calls. The training and testing datasets also comprise markers indicating whether a meeting success event occurred.

In some embodiments, the model is trained and tested using supervised learning techniques. Success events are defined based on meeting type (e.g., contract signing in a sales meeting). Furthermore, separate models for different types of events that can be further trained with specific organizational data to improve prediction accuracy.

In the example embodiment, the machine learning model receives an input vector every second, containing metadata from the past N seconds and constant meeting context data. The model continuously predicts the probability of meeting success, expressed as a percentage (PP).

Furthermore, the model is trained and tested with datasets containing historical meeting metadata and success event markers. Supervised learning is employed to refine the model's accuracy. The system is designed to predict various events during a meeting by recognizing patterns in the metadata. Different pretrained models are used for different types of events, and these models can be further customized for specific organizations.

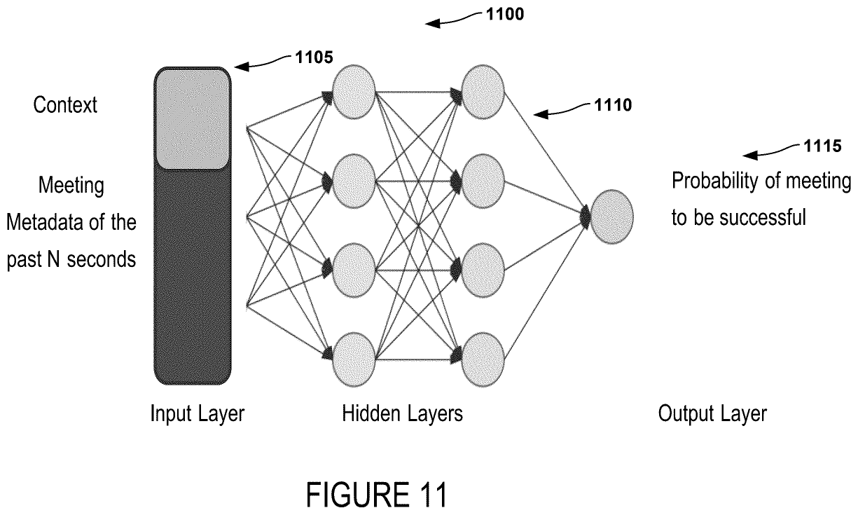

FIG. 12 illustrate an example timeline 1200 for a meeting for use with the process 1000 (shown in FIG. 10). FIG. 12 shows meeting metadata with a success event marker. At time tₓₙ, the model has the metadata of tₓ₁ to tₓₙ and learns to predict the success of an event that will occur at time t_{z}.

FIG. 13 illustrates an example dashboard 1300 for use with process 1000 (shown in FIG. 10). The dashboard 1300 that visualizes real-time predictions of meeting success and various engagement metrics. This dashboard 1300 includes a success probability indicator 1305, an engagement graph 1310, and a table 1315 displaying relative speaking times of participants. The dashboard 1300 shown in FIG. 7 is an example of screenshots of the dashboard 1300 displaying the likelihood of meeting success (PP) 1305, an engagement graph 1310, and a relative speaking time (RSTn) table 1315.

The meeting success probability (PP) 1305 is displayed as a percentage indicating the likelihood of the meeting being successful. Derived from a machine learning model that processes meeting metadata and contextual information.

The engagement graph 1310 visualizes high- and low-engagement phases of users relative to the meeting's timeline. This includes views for combined engagement and a comparison between organization participants and external participants. Engagement is assessed using Diarization of All Participants (DAP) which may include metrics such as interaction frequency, response times, and other indicators of participant involvement.

The relative speaking time (RSTn) Table 1315 displays each participant's speaking duration as a percentage of the total speaking time of all participants. The table 1315 helps in understanding the distribution of conversation and identifying dominant speakers.

For the meeting success probability (PP) 1305, the machine learning model continuously processes meeting metadata and provides an updated probability of meeting success. This probability is displayed prominently on the dashboard to inform users about the real-time likelihood of meeting success.

For the engagement graph 1310, the dashboard 1300 generates an engagement graph 1310 that maps user engagement over the meeting timeline. Engagement data is split into combined engagement levels and a comparative view between organizational and external participants. High-engagement phases are highlighted to indicate active participation periods, while low-engagement phases indicate potential areas of improvement.

For the relative speaking time (RSTn) 1315, the dashboard 1300 calculates the speaking time of each participant relative to the total speaking time. This data is displayed in a table format, providing insights into the distribution of speaking time among participants.

Accordingly, the dashboard 1300 provides meeting facilitators and participants with real-time insights into meeting dynamics. It helps identify areas where engagement can be improved and ensures balanced participation among attendees.

In the example embodiment, a system 100 for dynamically generating and analyzing metadata for online meetings it provided. The system 100 includes a computer device 120 comprising at least one processor 705 in communication with at least one memory device 710. The at least one memory device 710 stores computer-implemented instructions that cause the at least one processor 705 to perform actions. In the example embodiment, the computer device 120 stores at least one trained machine learning model trained to analyze metadata of a meeting and to output a probability of success of that meeting.

The computer device 120 retrieves metadata for an ongoing online meeting between a plurality of participants. The metadata includes at least one or more of meeting date and time and participant locations, time zone of each participant of the plurality of participants, communication interaction between each of the participants of the plurality of participants, volume of each participant of the plurality of participants, pitch of each participant of the plurality of participants, rate of speaking of each participant of the plurality of participants, and duration of speaking for each participant of the plurality of participants. In some embodiments, the metadata for the ongoing online meeting is for a plurality of seconds of the online meeting occurring prior to this point in time. In other embodiments, the metadata for the ongoing online meeting is for all of the online meeting occurring prior to this point in time.

The computer device 120 execute the trained machine learning model using the retrieved metadata as input. The trained machine learning model outputs a probability score indicative of the meeting's likely success.

The computer device 120 generates and displays a user interface including the probability score. The probability score ranges from 0 to 1.

In some embodiments, the computer device 120 visualizes the probability score as at least one of a diagram and a graph on the user interface.

In some embodiments, the computer device 120 trains the trained machine learning model using metadata from a plurality of historical online meetings. In some further embodiments, the computer device 120 trains the trained machine learning model using a success indicator for each of the plurality of historical online meeting. The success indicator is provided by one or more users associated with the corresponding online meeting. The success indicator is defined based on a type of the online meeting. In additional embodiments, the computer device 120 collects a plurality of historical meeting data from the plurality of historical online meetings. The computer device 120 processes the plurality of historical meeting data to extract relevant features. Then the computer device 120 trains a machine learning model using the extracted relevant features.

In further embodiments, the computer device 120 inputs the metadata for an ongoing online meeting as an input vector into the trained machine learning model. The computer device 120 generates the input vector from the metadata for the ongoing online meeting.

In some further embodiments, the computer device 120 outputs a probability score indicative of the meeting's likely success on a periodic basis.

In some further embodiments, the computer device 120 predicts one or more events in the online meeting based upon the trained machine learning model.

In some further embodiments, the trained machine learning model is trained with online meeting metadata from meetings with a specific organization to improve prediction accuracy.

In some further embodiments, the computer device 120 generates and displays an engagement graph that visualizes engagement phases of participants relative to a timeline for the online meeting.

In some further embodiments, the computer device 120 generates and displays a relative speaking time (RSTn) table that illustrates each participant's speaking duration relation to a total speaking time of the plurality of participants.

In some further embodiments, the computer device 120 displays a comparative view between participants internal to an organization and participants external to the organization.

In the example embodiment, a system 100 for dynamically generating and analyzing metadata for online meetings is provided. The system 100 comprising a computer device 120 comprising at least one processor 705 in communication with at least one memory device 710. The at least one memory device 710 stores computer-implemented instructions that cause the at least one processor 705 to perform the steps described herein.

In the example embodiment, the computer device 120 receives at least one stream of at least one of audio and video of an online meeting. The at least one stream includes a plurality of participants participating in the online meeting.

The computer device 120 extracts a plurality of metadata from the at least one stream.

The computer device 120 performs diarization on the at least one stream and the plurality of metadata the at least one stream to generate online meeting information. The online meeting information includes information about participation for the plurality of participants in the online meeting.

The computer device 120 analyzes the online meeting information to calculate one or more key performance indicators (KPIs).

The computer device 120 generates a report of the key performance indicators to be displayed to one or more participants in the online meeting.

In some further embodiments, the computer device 120 traverses a diarization data structure for each participant stored in a datastore. The computer device 120 calculates a speaking time for each participant of the plurality of participants in the online meeting. The computer device 120 generates a visual representation of relative speaking times of each participant of the plurality of participants based on relative speaking time. The computer device 120 adds the visual representation of relative speaking times of each participant to the report.

In some further embodiments, the computer device 120 creates a sequence diagram wherein an x-axis represents elapsed meeting time and a y-axis features one line per participant, and where a size of a bubble indicates a corresponding speech duration. The computer device 120 adds the sequence diagram the report.

In some further embodiments, the computer device 120 calculates a centrality for each participant of the plurality of participants to measure their engagement and influence during the online meeting. The computer device 120 generates a visualization of the centrality for each participant. The computer device 120 adds the visual representation of the centrality for each participant to the report.

In some further embodiments, the computer device 120 analyzes relations between the plurality of participants to determine interaction patterns.

In some further embodiments, the computer device 120 detects a call termination signal from an online meeting provider. The computer device 120 generates a request for the report in response to the call termination signal.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), a reduced instruction set circuit (RISC), an application specific integrated circuit (ASIC), logic circuits, and any other circuit or processor capable of executing the functions described herein. The above examples are example only and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

In another example, a computer program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

“Optional” or “optionally” means that the subsequently described event or circumstance may or may not occur, and that the description includes instances where the event occurs and instances where it does not.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein can include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for dynamically generating and analyzing metadata for online meetings, the system comprising a computer device comprising at least one processor in communication with at least one memory device, wherein the at least one memory device stores computer-implemented instructions that cause the at least one processor to:
store at least one trained machine learning model trained to analyze metadata of a meeting and to output a probability of success of that meeting;
retrieve metadata for an ongoing online meeting between a plurality of participants;
execute the trained machine learning model using the retrieved metadata as input, wherein the trained machine learning model outputs a probability score indicative of the meeting's likely success; and
generate and display a user interface including the probability score.

2. The system of claim 1, wherein the metadata includes at least one or more of meeting date and time and participant locations, time zone of each participant of the plurality of participants, communication interaction between each of the participants of the plurality of participants, volume of each participant of the plurality of participants, pitch of each participant of the plurality of participants, rate of speaking of each participant of the plurality of participants, and duration of speaking for each participant of the plurality of participants.

3. The system of claim 1, wherein the at least one processor is further programmed to visualize the probability score as at least one of a diagram and a graph on the user interface.

4. The system of claim 1, wherein the at least one processor is further configured to train the trained machine learning model using metadata from a plurality of historical online meetings.

5. The system of claim 4, wherein the trained machine learning model is further trained using a success indicator for each of the plurality of historical online meeting.

6. The system of claim 4, wherein the at least one processor is further programmed to:
collect a plurality of historical meeting data from the plurality of historical online meetings;
processes the plurality of historical meeting data to extract relevant features; and
train a machine learning model using the extracted relevant features.

7. The system of claim 1, wherein the at least one processor is further programmed to input the metadata for an ongoing online meeting as an input vector into the trained machine learning model.

8. The system of claim 7, wherein the at least one processor is further programmed to generate the input vector from the metadata for the ongoing online meeting.

9. The system of claim 1, wherein the at least one processor is further programmed to predict one or more events in the online meeting based upon the trained machine learning model.

10. The system of claim 1, wherein the at least one processor is further programmed to generate and display an engagement graph that visualizes engagement phases of participants relative to a timeline for the online meeting.

11. The system of claim 1, wherein the at least one processor is further programmed to generate and display a relative speaking time (RSTn) table that illustrates each participant's speaking duration relation to a total speaking time of the plurality of participants.

12. The system of claim 1, wherein the at least one processor is further programmed to display a comparative view between participants internal to an organization and participants external to the organization.

13. A method for dynamically generating and analyzing metadata for online meetings, the method implemented by a computer device comprising at least one processor in communication with at least one memory device, wherein the method comprises:
storing at least one trained machine learning model trained to analyze metadata of a meeting and to output a probability of success of that meeting;
retrieving metadata for an ongoing online meeting between a plurality of participants;
executing the trained machine learning model using the retrieved metadata as input, wherein the trained machine learning model outputs a probability score indicative of the meeting's likely success; and
generating and displaying a user interface including the probability score.

14. A system for dynamically generating and analyzing metadata for online meetings, the system comprising a computer device comprising at least one processor in communication with at least one memory device, wherein the at least one memory device stores computer-implemented instructions that cause the at least one processor to:
receive at least one stream of at least one of audio and video of an online meeting, wherein the at least one stream includes a plurality of participants participating in the online meeting;
extract a plurality of metadata from the at least one stream;
perform diarization on the at least one stream and the plurality of metadata the at least one stream to generate online meeting information, wherein the online meeting information includes information about participation for the plurality of participants in the online meeting;
analyze the online meeting information to calculate one or more key performance indicators (KPIs); and
generate a report of the key performance indicators to be displayed to one or more participants in the online meeting.

15. The system of claim 14, wherein the at least one processor is further programmed to traverse a diarization data structure for each participant stored in a datastore.

16. The system of claim 14, wherein the at least one processor is further programmed to:
calculate a speaking time for each participant of the plurality of participants in the online meeting;
generate a visual representation of relative speaking times of each participant of the plurality of participants based on relative speaking time; and
add the visual representation of relative speaking times of each participant to the report.

17. The system of claim 14, wherein the at least one processor is further programmed to:
create a sequence diagram wherein an x-axis represents elapsed meeting time and a y-axis features one line per participant, and wherein a size of a bubble indicates a corresponding speech duration; and
add the sequence diagram the report.

18. The system of claim 14, wherein the at least one processor is further programmed to:
calculate a centrality for each participant of the plurality of participants to measure their engagement and influence during the online meeting;
generate a visualization of the centrality for each participant; and
add the visual representation of the centrality for each participant to the report.

19. The system of claim 14, wherein the at least one processor is further programmed to analyze relations between the plurality of participants to determine interaction patterns.

20. The system of claim 14, wherein the at least one processor is further programmed to:
detect a call termination signal from an online meeting provider; and
generate a request for the report in response to the call termination signal.
